(19) United States
(12) Patent Application Publication
(10) Pub. No.: US 2012/0019020 A1
(43) Pub. Date: Jan. 26, 2012

(54) INTEGRATED REFRIGERATOR CAR CARRIAGE STRUCTURE AND MOUNTING METHOD THEREOF

(76) Inventor: Hong Wang, Guangdong (CN)

(21) Appl. No.: 13/262,237

(22) PCT Filed: Mar. 30, 2010
(86) PCT No.: PCT/CN2010/071412

§ 371 Date: Sep. 30, 2011

(30) Foreign Application Priority Data
Apr. 3, 2009 (CN) 200910038380.7

(51) Int. Cl. B60P 3/20; B23P 25/00; B29C 67/20

(52) U.S. Cl. 296/24.35; 264/321; 29/527.1

(57) ABSTRACT

An integrated refrigerator car carriage structure is disclosed. The carriage structure has a protection layer (8) and an insulating layer. The insulating layer is composed of a left side plate (1), a right side plate (4), a head plate (2), a sole plate (5), a fore sealing plate (3) and a back sealing plate (6), that are injection molded with polyurethane material. The protection layer is adhered on the insulating layer. The plates of the insulating layer are connected with each other in a seamless manner, so as to form a unitary structure. It discloses a mounting method of the integrated refrigerator car carriage structure also. The structure is simple and easy to manufacture with improved space utilization rate and heat insulation performance.

### FIELD OF THE INVENTION

The invention relates to refrigerator car carriage, particularly to irregular refrigerator car carriage, more specifically, to an integrated refrigerator car carriage structure and mounting method thereof.

### BACKGROUND OF THE INVENTION

At the present, the irregular cold storage compartment on the domestic market mainly uses six-plane composite panels in the original car assembled combination and used profiles for fastening at the corners. The sole plate, the head plate, the left side plate, the right side plate, the fore sealing plate and the back sealing plate (containing backdoor), which compose the carriage, are all made by sandwiching plates stuck together. In this way, the production need using duplex of panel and more of glue viscosity received, material using volume more, manufacturing cycle more long and cost higher; the plates fit poor with the original carriage body, it waste lots of loading space. And the broken cold bridge processing of the carriage is not good enough, cool leakage phenomenon is relatively serious.

### SUMMARY OF THE INVENTION

One object of the present invention is to provide an integrated refrigerator car carriage structure and mounting method thereof for the irregular refrigerator car carriage. The structure is simple and easy to manufacture with improved space utilization rate and heat insulation performance.

To solve the technical problems above, in accordance with one embodiment of the present invention, an integrated refrigerator car carriage structure, the carriage structure has a protection layer and an insulating layer, the protection layer is the original carriage body, the insulating layer is composed of a left side plate, a right side plate, a head plate, a sole plate, a fore sealing plate and a back sealing plate, that are injection molded with polyurethane material. The plates of the insulating layer are connected with each other in a seamless manner, so as to form an integrated structure, and the insulating layer glues protection layer to form a whole. After molding of the carriage, the polyurethane insulating layer form as a whole, with no seam, no necessary to strengthen the skeleton, the strength and heat insulation performance of the carriage body get bigger promotion.

According to one embodiment of the structure of the present invention, the shape of the insulating layer fits in with the protection layer. Insulating layer shape adapts to protection layer shape to achieve the maximum utilization of interior space.

According to one embodiment of the structure of the present invention, the inner surface of insulating layer is covered with glass plates or choi steel as inner surface layer.

In accordance with another embodiment of the present invention, an integrated refrigerator car carriage structure mounting method, the mounting method includes the steps of:

Step A. Mount the fore sealing plate at the fore of the protection layer of the carriage structure, mount the sole plate on the bottom of the protection layer of the carriage structure;

Step B. On The basis of the sole plate, mount the inner surface layer on the both sides and undersurface of the carriage, leave an injection space between the protection layer and the inner surface layer;

Step C. Make a molding plate in the carriage structure, the molding plate matches the inner surface layer;

Step D. Inject high density polyurethane foam to the injection groove by high pressure injection in sections;

Step E. Mount the back sealing plate, injection mold in high pressure, mount the door on the back sealing plate.

The refrigerator car carriage direct injection foaming molding in the protection layer, it makes an effective use of protection layer panel as outer face skin, with no glue used, the polyurethane foam is bonded to protection layer tightly, it increases the strength of the protection layer panels, and can also absorb the vibration and impact of the protection layer panels when driving. By broken cold bridge processing of the whole carriage, the usage of metal strengthen pieces reduce, with no easy heat conduction piece communicating the inside and the outside, cool leakage phenomenon recede obviously. Compared with the general assembly carriage, manufacturing processes are highly simplified, the efficiency improved, the most mounting are completed inside the carriage, the mounting occupy a smaller space.

According to one embodiment of the method of the present invention, during the step A), the fore sealing plate and the sole plate directly foam molding on the internal surface of the protection layer. It makes the fore sealing plate and sole plate, which are the basis of latter mounting, glue protection layer to form a whole.

According to one embodiment of the method of the present invention, during the step B, the inner surface layer assembled adapt to the surface changes of the protection layer, and parallel to protection layer basically.

According to one embodiment of the method of the present invention, during the step D, inject high density polyurethane foam to the injection groove by high pressure injection in sections. High density polyurethane is more excellent in thermal insulation properties and adhesive performance than general polyurethane. It improves heat insulation performance of the carriage, and makes the plates glue the carriage better.

According to one embodiment of the method of the present invention, during the step E, molding the back sealing plate by injection mold in high pressure, and hermetically combine with the left side plate, the right side plate, the fore sealing plate and the sole plate.

According to one embodiment of the method of the present invention, the inner surface layer is glass plates or choi steel.

Compared with the prior technologies, the present invention at least has the following advantages:

In terms of carriage structure, the insulating layer glues protection layer to form a whole, the plates of the insulating layer are connected with each other in a seamless manner, so as to form an integrated structure, and adapt to the surface change of the protection layer. It maximizes the inner space, and enlarge the loading space, the cold air could have a more sufficient circulating path. The structure is simple and easy to manufacture with improved heat insulation performance.

In terms of carriage manufacturing engineering, it makes an effective use of protection layer panel as outer face skin, with no glue used, the polyurethane foam is bonded to protection layer tightly, and increases the strength of the protection layer. By broken cold bridge processing of the whole carriage, reduce the heat conduction of the carriage inside and outside. The manufacturing processes are highly simplified, the efficiency improve, the most mounting are completed inside the carriage, the mounting occupy a smaller space, make it suitable for large scale production.

### DESCRIPTION OF THE DRAWINGS

FIG. 1 is an appearance view of the refrigerator car of the present invention;

FIG. 2 is a back view of the carriage of the present invention;

FIG. 3 is a cross-sectional view of the carriage of the present invention;

FIG. 4 is a molding injection view of the carriage of the present invention;

FIG. 5 is a flow diagram of integrated structure of the carriage of the present invention.

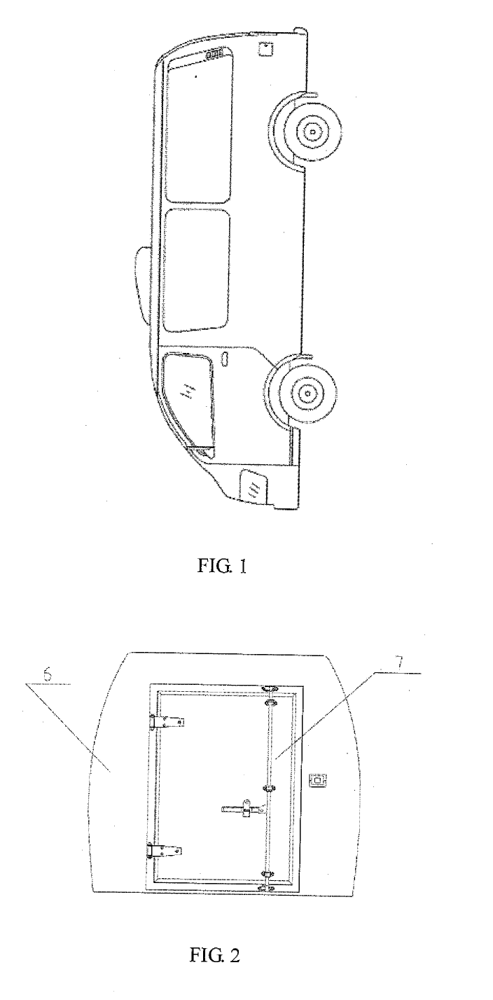

### DETAILED DESCRIPTION OF THE INVENTION

A further description of the invention combined the manual illustrated is following.

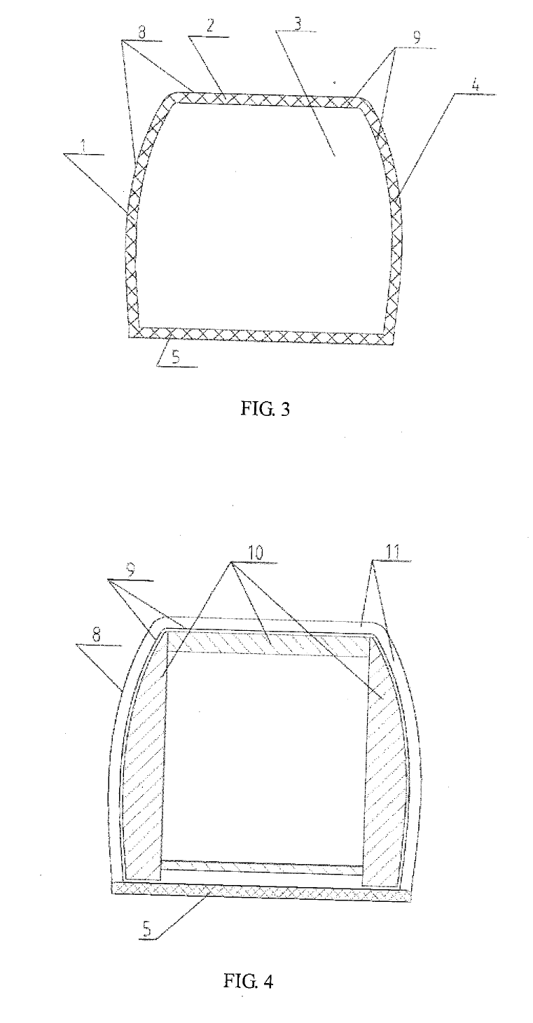

Referring to FIG. 2 and FIG. 3, an integrated refrigerator car carriage structure, the carriage structure has a protection layer 8 and an insulating layer, the protection layer 8 is the original carriage body, it's general metal carriage. The insulating layer is composed of a left side plate 1, a head plate 2, a fore sealing plate 3, a right side plate 4, a sole plate 5 and a back sealing plate 6, that are injection molded with polyurethane material. The insulating layer glues protection layer 8 to form a whole, and the shape of the insulating layer fits in with the protection layer 8.

The left side plate 1, the head plate 2, the fore sealing plate 3, the right side plate 4, the sole plate 5, and the back sealing plate 6, which compose the insulating layer, are connected with each other in a seamless manner, the insulating layer is an integrated structure. To further improve the heat insulation performance and clean of the carriage, the inner surface of insulating layer is covered with glass plates as inner surface layer 9. The glass plates layer seprate the insulating layer and carriage space, it not only make the carriage artistic, but also prevent the goods in the carriage from striking insulating layer directly.

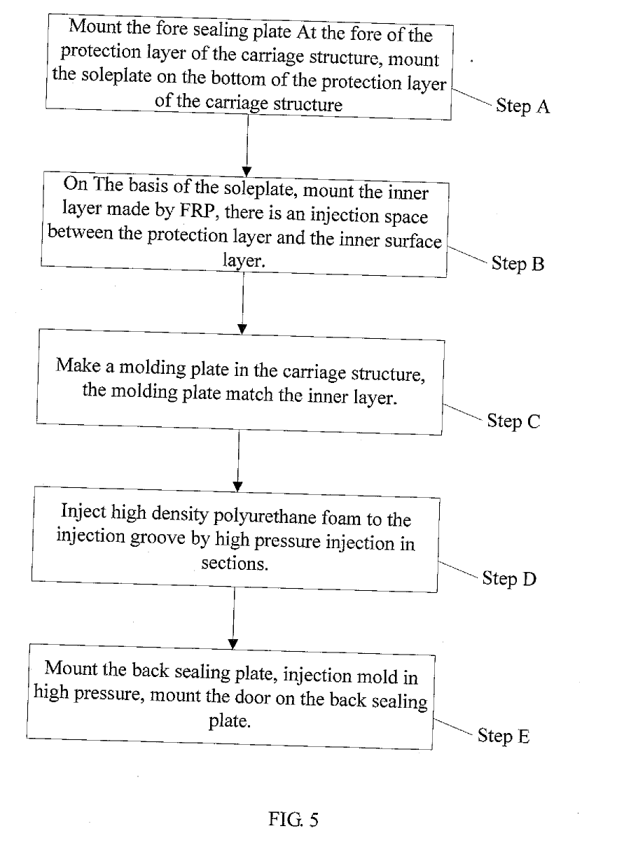

Referring to FIG. 4 and FIG. 5, an integrated refrigerator car carriage structure mounting method, the method comprising the steps of:

Step A. Foam forming the fore sealing plate 3 in the former surface of the protection layer 8, and foam forming the sole plate 5 in the undersurface of the protection layer 8;

Step B. On The basis of the sole plate 5, mount the inner surface layer 9 made by glass plates on both sides and undersurface of the carriage, leave an injection space between the protection layer 8 and the inner surface layer 9. The inner surface layer 9 parallel to protection layer 8 basically;

Step C. Make a molding plate 10 in the carriage structure, the molding plate 10 matches the inner surface layer 9;

Step D. Inject high density polyurethane foam to the injection groove 11 by high pressure injection in sections;

Step E. Molding the back sealing plate 6 by injection mold in high pressure, and hermetically combine with the left side plate 1, the fore sealing plate 2, the right side plate 4 and the sole plate 5, then mount the backdoor 7 on the back sealing plate 6.

In accordance with the present invention, after molding of the carriage, the polyurethane insulating layer form as a whole, with no seam, no necessary to strengthen the skeleton, the strength and heat insulation performance of the carriage body get bigger promotion. In terms of carriage manufacturing engineering, it makes an effective use of protection layer panel as outer skin, with no glue used, the polyurethane foam is bonded to protection layer tightly, it increases the strength of the protection layer, and can also absorb the vibration and impact of the protection layer panels when driving. The insulating layer adapt to the surface change of the protection layer. It maximizes the inner space, and enlarge the loading space, the cold air could have a more sufficient circulating path. By broken cold bridge processing of the whole carriage, the usage of metal strengthen pieces reduce, with no easy heat conduction piece communicating the inside and the outside, cool leakage phenomenon recede obviously. Compared with the general assembly carriage, manufacturing processes are highly simplified, the efficiency improve, the most mounting are completed inside the carriage, the mounting occupy a smaller space, make it suitable for large scale production.

It should be noted that, the present invention is mainly in accordance of irregular carriage, suitable for different size and shape of carriage. Any structure and mounting method relates to this invention is in the scope of the invention protection issues.

While the present invention has been illustrated by the above description of the preferred embodiments thereof, while the preferred embodiments have been described in considerable detail, it is not intended to restrict or in any way limit the scope of the appended claims to such details. Other advantages and modifications within the spirit and scope of the present invention will readily appear to those skilled in the art. Therefore, the present invention is not limited to the specific details and the illustrative examples shown and described.

What is claimed is:

1. An integrated refrigerator car carriage structure, the carriage structure has a protection layer and an insulating layer, the insulating layer is composed of a left side plate, a right side plate, a head plate, a sole plate, a fore sealing plate, and a back sealing plate, that are injection molded with polyurethane material, the left side plate, the right side plate, the head plate, the sole plate, the fore sealing plate, and the back sealing plate are connected with each other in a seamless manner, the protection is an integrated structure, and the insulating layer glues protection layer to form a whole.

2. The integrated refrigerator car carriage structure as claimed in claim 1, wherein a shape of the insulating layer fits in with the protection layer.

3. The integrated refrigerator car carriage structure as claimed in claim 1, wherein an inner surface of the insulating layer is covered with glass plates or choi steel.

4. An integrated refrigerator car carriage structure mounting method, the method comprising the steps of:
Step A. Mounting the fore sealing plate at the fore of the protection layer of the carriage structure, mounting the sole plate on the bottom of the protection layer of the carriage structure;
Step B. mounting the inner surface layer made by glass plates on the both sides and undersurface of the carriage on the basis of the sole plate, leaving an injection space between the protection layer and the inner surface layer;
Step C. making a molding plate in the carriage structure, the molding plate matching the inner surface layer;
Step D. injecting high density polyurethane foam to the injection groove by high pressure injection in sections;
Step E. mounting the back sealing plate, and mounting the door on the back sealing plate.

5. The method as claimed in claim 4, wherein during the step A, the fore sealing plate and the sole plate directly foam molding on the internal surface of the protection layer.

6. The method as claimed in claim 4, wherein during the step B, the inner surface layer assembled adapting to the surface changes of the protection layer, and is parallel to the protection layer.

7. The method as claimed in claim 4, wherein during the step D, high density polyurethane foam is injected to the injection groove by high pressure injection in sections.

8. The method as claimed in claim 4, wherein the inner surface layer is glass plates or choi steel.

9. The method as claimed in claim 4, wherein during the step E, the back sealing plate is molded by injecting mold in high pressure, and hermetically combined with the left side plate, the right side plate, the fore sealing plate, and the sole plate.
